(19) United States
(12) Patent Application Publication
(10) Pub. No.: US 2009/0109673 A1
(43) Pub. Date: Apr. 30, 2009

(54) PRISM SHEET AND BACKLIGHT MODULE USING THE SAME

(75) Inventor: SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/949,057

(22) Filed: Dec. 3, 2007

(30) Foreign Application Priority Data
Oct. 24, 2007 (CN) 200710202233.X

(51) Int. Cl. F21V 5/00; G02B 5/04

(52) U.S. Cl. 362/246; 359/833

(57) ABSTRACT

An exemplary prism sheet consists of a transparent main body. The transparent main body includes a surface and a plurality of spherical micro-protrusions. The spherical micro-protrusions are integrally formed on the surface. A backlight module using the present prism sheet is also provided.

### CROSS-REFERENCE TO RELATED APPLICATIONS

This application is related to five co-pending U.S. patent applications, which are: applications Ser. No. 11/933,439 and Ser. No. 11/933,441, filed on Nov. 1, 2007, and both entitled “PRISM SHEET AND LIQUID CRYSTAL DISPLAY DEVICE USING THE SAME”, application Ser. No. 11/946,860 and Ser. No. 11/946,862, filed on Nov. 29, 2007, and both entitled “PRISM SHEET AND LIQUID CRYSTAL DISPLAY DEVICE USING THE SAME”, and application Ser. No. [to be determined], with Attorney Docket No. U.S.15564, and entitled “PRISM SHEET AND LIQUID CRYSTAL DISPLAY DEVICE USING THE SAME”. In all these co-pending applications, the inventor is Shao-Han Chang. All of the co-pending applications have the same assignee as the present application. The disclosures of the above identified applications are incorporated herein by reference.

### BACKGROUND OF THE INVENTION

1. Field of the Invention

The present invention relates to prisms, and particularly to a prism sheet used in a backlight module.

2. Discussion of the Related Art

In a liquid crystal display device (LCD device), liquid crystal is a substance that does not illuminate light by itself. Instead, the liquid crystal relies on light received from a light source, in order that the liquid crystal can facilitate the display of information. In the case of a typical liquid crystal display device, a backlight module powered by electricity supplies the needed light.

FIG. 6 is a typical backlight module 100 employing a typical prism sheet 10. The backlight module 100 includes a housing 11 and a plurality of lamps 12 positioned in the housing 11. The backlight module 100 further includes a light diffusion plate 13, and a prism sheet 10 in that order. The prism sheet 10 includes a base layer 101 and a prism layer 103 formed on the base layer 101. The prism layer 103 has a plurality of prism lenses 105 each having a triangular cross section. The prism lenses 105 are arranged regularly, and each extends along a direction parallel to one edge of the prism sheet 10. In use, light emitted from the lamps 12 enters the prism sheet 10 after scattered in the diffusion plate 13. The light is refracted and concentrated by the prism lenses 105 of the prism sheet 10, and then the light finally propagates into the LCD panel.

Generally, a method of manufacturing the prism sheet 10 includes the following steps. First, a melted ultraviolet-cured transparent resin is coated on the base layer 101, and then the melted ultraviolet-cured transparent resin having triangular cross section is solidified to form the prism layer 103 having prism lenses 105. This results in that the prism lenses 105 of the prism layer 103 are usually damaged or scratched due to their poor rigidity and mechanical strength.

In order to protect the prism layer 103 of the prism sheet 10 in use, the backlight module 100 usually further includes an upper light diffusion film 14 disposed on the prism sheet 10. Although the upper light diffusion film 14 and the prism sheet 10 are in contact with each other, a plurality of air pockets still exist at the boundaries between the light diffusion film 14 and the prism sheet 10. When the backlight module 100 is in use, light passes through the air pockets, and some of the light undergoes total reflection at one or another of the corresponding boundaries. In addition, the upper light diffusion film 14 may absorb an amount of the light from the prism sheet 10. As a result, a brightness of light illumination of the backlight module 100 is reduced.

What is needed, therefore, is a new prism sheet and a backlight module using the prism sheet that can overcome the above-mentioned shortcomings.

### SUMMARY

In one aspect, a prism sheet according to a preferred embodiment consists of a transparent main body. The transparent main body includes a surface and a plurality of spherical micro-protrusions. The spherical micro-protrusions are integrally formed on the surface.

In another aspect, a backlight module according to a preferred embodiment includes a plurality of lamps, a light diffusion plate and a prism sheet. The light diffusion plate is located above the lamps. The prism sheet is disposed on the light diffusion plate. The prism sheet is the same as described in a previous paragraph.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is a side, cross-sectional view of a backlight module using a prism sheet according to a first preferred embodiment of the present invention.

FIG. 2 is an isometric view of the prism sheet of FIG. 1.

FIG. 3 is a side, cross-sectional view of the prism sheet of FIG. 2, taken along line III-III thereof.

FIG. 4 is a top plane view of a prism sheet according to a second preferred embodiment of the present invention.

FIG. 5 is a top plane view of a prism sheet according to a third preferred embodiment of the present invention.

FIG. 6 is a side, cross-sectional view of a conventional backlight module using a typical prism sheet.

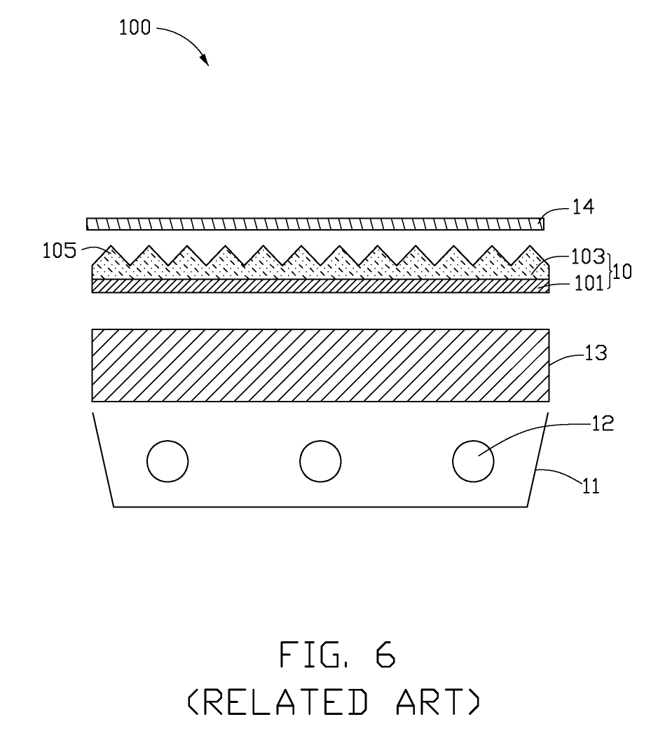

### DETAILED DESCRIPTION OF THE PREFERRED EMBODIMENTS

Reference will now be made to the drawings to describe preferred embodiments of the present prism sheet and backlight module, in detail.

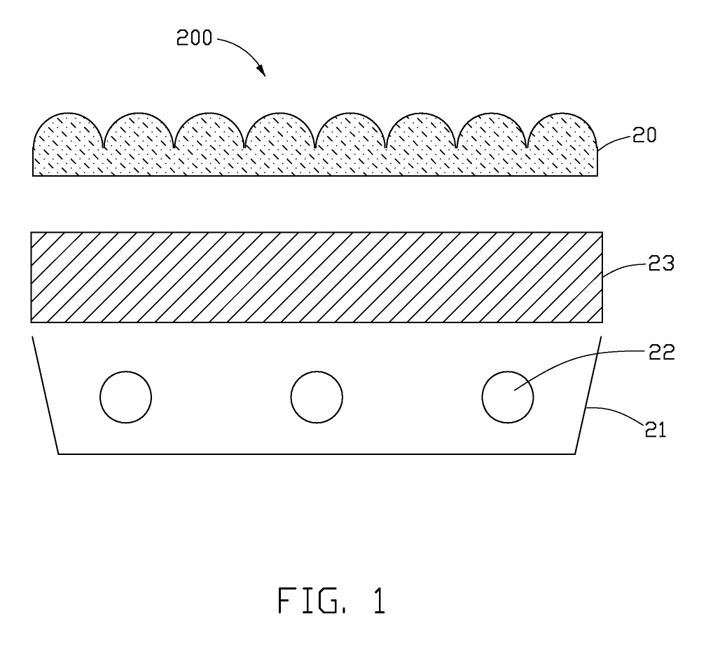

Referring to FIG. 1, a backlight module 200 in accordance with a first preferred embodiment of the present invention is shown. The backlight module 200 includes a prism sheet 20, a housing 21, a plurality of lamps 22 and a light diffusion plate 23. The lamps 22 are regularly aligned above a base of the housing 21. The light diffusion plate 23 and the prism sheet 20 are stacked on the top of the housing 21 in that order.

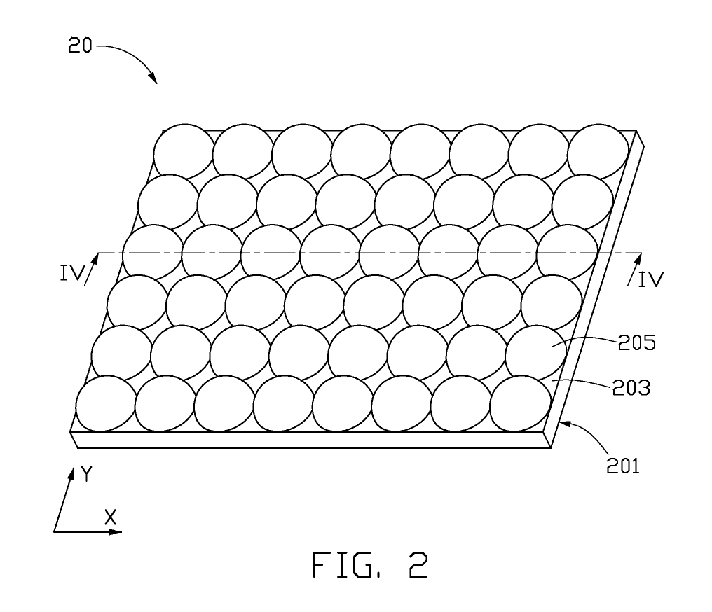

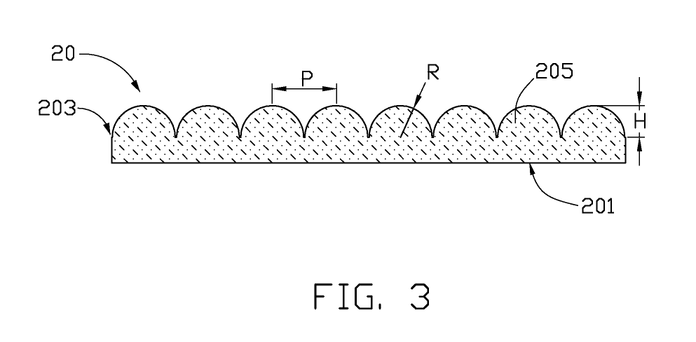

Referring to FIGS. 2 and 3 together, the prism sheet 20 has a transparent main body. The transparent main body includes a light input surface 201, a light output surface 203, and a plurality of spherical micro-protrusions 205. The light input surface 201 and the light output surface 203 are on opposite sides of the main body. The spherical micro-protrusions 205 are integrally formed on the light output surface 203 by injection molding technology. The prism sheet 20 is positioned on the light diffusion plate 23 such that the light input surface 201 is adjacent to the light diffusion plate 23 and the light output surface 203 faces away from the light diffusion plate 23.

In the first embodiment, the spherical micro-protrusions 205 are formed on the light output surface 203 of the prism sheet 20 in a regular matrix manner. Rows and columns of the spherical micro-protrusions 205 in the matrix are parallel to the edges of the prism sheet 20 (along an X-direction or a Y-direction) correspondingly. A pitch P between adjacent centers of the micro-protrusions 205 is configured to be in the range from about 0.025 millimeters to about 1.5 millimeters. A radius R of each spherical micro-protrusion 205 is in a range from about a quarter of the pitch P to about double of the pitch P. A depth H of the spherical micro-protrusion 205 relative to the light output surface 203 is in the range from about 0.01 millimeters to the radius R. In this embodiment, the depth H equals to the radius R. In an alternative embodiment, each spherical micro-protrusion 205 is a part of a hemisphere micro-protrusion 205.

The light input surface 201 can be either a planar surface or a rough surface. The spherical micro-protrusions 205 of the light output surface 203 are configured for converging the received light from the light output surface 203. The thickness of the prism sheet 20 is preferably in a range from about 0.2 millimeters to about 2 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Referring to FIG. 1 again, the housing 21 is made of metal or plastic materials. An interior of the housing 21 is configured to be highly reflective.

The lamps 22 can be point light sources such as light emitting diodes or linear light sources such as cold cathode fluorescent lamps. In this embodiment, the lamps are the cold cathode fluorescent lamps.

In the backlight module 200, the spherical protrusions 205 have curve side surfaces in all direction, thus when the light exiting the prism sheet 20 via the light output surface 203, the light, from every direction, would converge by the spherical protrusions 205. The spherical micro-protrusions 205 are integrally formed on the light output surface 203, the materials of the spherical micro-protrusions 205 is same to that of the other portion of the prism sheet 20. Therefore, a bonding strength between the spherical micro-protrusions 205 and the other portion of the prism sheet 20 is enhanced, and rigidity and mechanical strength of the prism sheet 20 would be improved. And thus the prism sheet 20 is not easy to be damaged or scratched. Furthermore, the spherical micro-protrusions 205 are integrally formed on the light output surface 203, and there are no common interfaces in the prism sheet 20. Thus there is little or no back reflection at common interfaces, and an efficiency of utilization of light is increased. In addition, it is easy to mass-produce the prism sheet 20 via the injection molding method.

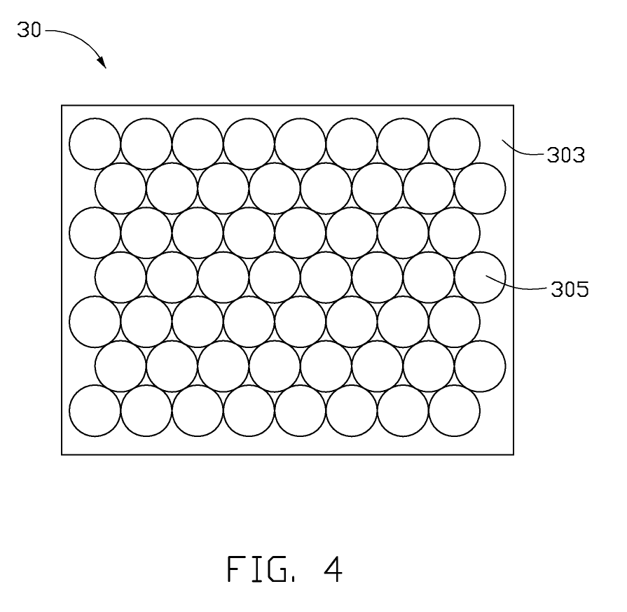

Referring to FIG. 4, a prism sheet 30 in accordance with a second preferred embodiment of the present invention is shown. The prism sheet 30 is similar in principle to the prism sheet 20. However, spherical micro-protrusions 305 are aligned side by side on a light output surface 303 of the prism sheet 30 in rows. Adjacent spherical micro-protrusions 305 in each row adjoin each other. The spherical micro-protrusions 305 in any two adjacent rows are staggered relative to each other yet abut each other. Thus a matrix comprised of offset rows of the spherical micro-protrusions 305 is formed. In another words, a honeycomb pattern of the spherical micro-protrusions 305 is formed.

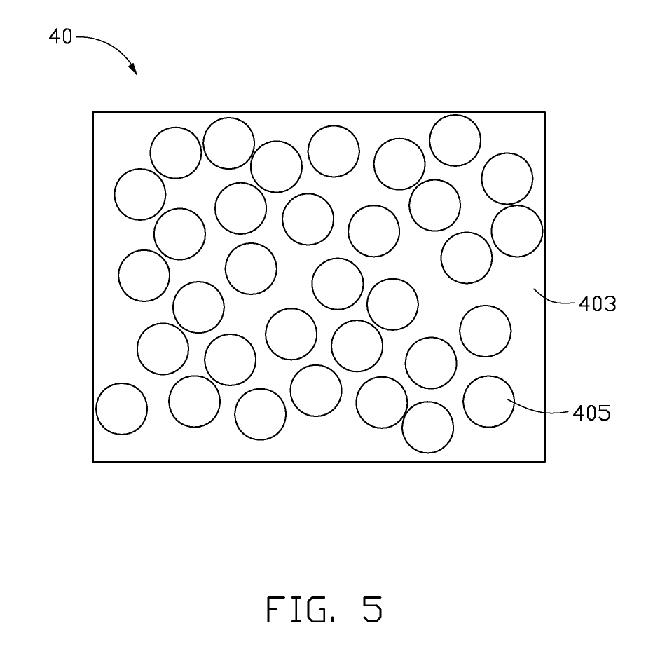

Referring to FIG. 5, a prism sheet 40 according to a third embodiment is shown. The prism sheet 40 is similar in principle to the prism sheet 30 of the second embodiment. A plurality of spherical micro-protrusions 405 are formed on a light output surface 403 in a random manner. When the prism sheet 40 is used in a liquid crystal device, a random arrangement of the micro-protrusions 405 is different from that of pixels of a liquid crystal display panel. Thus moiré pattern interference effect caused by the prism sheet 40 and the pixel pitch of the liquid crystal display panel is kept minimal or eliminated.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet consisting of a transparent main body, the transparent main body comprising a surface, and a plurality of spherical micro-protrusions integrally formed on the surface, wherein the spherical micro-protrusions are aligned side by side on the surface of the prism sheet in rows, adjacent spherical micro-protrusions in each row adjoin each other, and the spherical micro-protrusions in any two adjacent rows are staggered relative to each other and abut each other.

2. The prism sheet according to claim 1, wherein a pitch between adjacent centers of the spherical micro-protrusions is in the range from about 0.025 millimeters to about 1.5 millimeters.

3. The prism sheet according to claim 1, wherein a radius of each spherical micro-protrusion is in the range from about 0.01 millimeters to about 3 millimeters.

4. The prism sheet according to claim 1, wherein a height of each spherical micro-protrusion is configured to be in the range from 0.01 millimeters to the radius of each spherical micro-protrusion.

5. The prism sheet according to claim 1, wherein a thickness of the prism sheet is in a range from about 0.2 millimeters to about 2 millimeters.

6. (canceled)

7. The prism sheet according to claim 1, wherein the prism sheet is made of transparent material selected from the group consisting of polycarbonate, polymethyl methacrylate, polystyrene, copolymer of methylmethacrylate and styrene, and any combination thereof.

8. A backlight module comprising: a plurality of lamps, a light diffusion plate above the lamps, and a prism sheet disposed on the light diffusion plate, the prism sheet consisting of a transparent main body, the transparent main body comprising a surface, and a plurality of spherical micro-protrusions integrally formed on the surface, wherein the spherical micro-protrusions are aligned side by side on the surface of the prism sheet in rows, adjacent spherical micro-protrusions in each row adjoin each other, and the spherical micro-protrusions in any two adjacent rows are staggered relative to each other and abut each other.

9. The backlight module according to claim 8, wherein the surface with the spherical micro-protrusions thereon of the prism sheet faces away from the light diffusion plate.

10. The backlight module according to claim 8, wherein a pitch between adjacent centers of the spherical micro-protrusions is in the range from about 0.025 millimeters to about 1.5 millimeters.

11. The backlight module according to claim 8, wherein a radius of each spherical micro-protrusion is in the range from about 0.01 millimeters to about 3 millimeters.

12. The backlight module according to claim 8, wherein a height of each spherical micro-protrusion is configured to be in the range from 0.01 millimeters to the radius of each spherical micro-protrusion.

13. The backlight module according to claim 8, wherein a thickness of the prism sheet is in a range from about 0.2 millimeters to about 2 millimeters.

14. (canceled)

15. The backlight module according to claim 8, wherein the prism sheet is made of transparent material selected from the group consisting of polycarbonate, polymethyl methacrylate, polystyrene, copolymer of methylmethacrylate and styrene, and any combination thereof.

16. The backlight module according to claim 8, wherein the backlight module further comprises a housing, the lamps are regularly aligned above a base of the housing, the light diffusion plate and the prism sheet are stacked on the top of the housing in that order, and the housing is made of metal or plastic having high reflectivity inner surfaces.
